(19) United States
(12) Patent Application Publication
(10) Pub. No.: US 2020/0193386 A1
(43) Pub. Date: Jun. 18, 2020

(54) DATA STRUCTURE FOR ORGANIZING SCREENING DATA AND GENERATING WEIGHTED SCORES

(71) Applicant: JOURNEYFRONT, INC., American Fork, UT (US)

(72) Inventors: Nicholas John Lyon, Draper, UT (US); Daniel Jarvies Ash, Provo, UT (US); Erik Joseph Porfeli, Lewis Center, OH (US)

(21) Appl. No.: 16/719,499

(22) Filed: Dec. 18, 2019

Related U.S. Application Data
(60) Provisional application No. 62/781,501, filed on Dec. 18, 2018.

(51) Int. Cl. G06Q 10/10; G06F 16/9535; G06Q 10/06

(52) U.S. Cl. CPC G06Q 10/1053; G06Q 10/063112; G06Q 10/06398; G06F 16/9535

(57) ABSTRACT

Storing and organizing pre-hiring screening data of multiple candidates and generating weighted scores using different weights. The task-specific data structure includes a task step table that stores multiple task steps. Each of the task steps includes one or more step activities, each of which corresponds to either (1) one or more questions, or (2) one or more assessments. Each question is associated with a question weight, each an attribute weight and/or an attribute weight, and each assessment is associated with an assessment weight and/or an attribute weight. Data related to the one or more questions or the one or more assessments are received and recorded in the task-specific data structure. Scores related to the questions and assessments are weighted based on the question weights, assessment weights, attribute weight, and/or additional weights.

### CROSS REFERENCE TO RELATED APPLICATIONS

This application claims priority to and the benefit of U.S. provisional Patent application Ser. No. 62/781,501, filed on Dec. 18, 2018, entitled DECISION VALIDATION AND OUTCOME PREDICTION SOFTWARE, which is incorporated herein in their entireties by reference.

### BACKGROUND

The hiring process begins when a company identifies the need to fill a position. The typical steps of the hiring process may vary depending on the role of the candidate that is to be hired and the organization that is hiring. In general, the most important step of the hiring process is the step of selecting candidates, which includes screening calls, reviewing applications, selecting the right candidates to interview, performing various pre-employment tests and checks, and choosing between candidates to make the hiring decision.

Once an organization identifies a hiring need, the hiring staff then starts by generating a job description that includes a prioritized list of job requirements, special qualifications, desired characteristics, and requisite experience. The job description may then be posted at a various job posting sites, job fairs, industry publications and events, local newspaper advertisements, and/or word-of-mouth websites and social media platforms. Candidates who see the job posting may then submit applications via various channels. In many cases, the applications are reviewed by hiring staff. The hiring staff may eliminate any candidate who does not meet the minimum requirements for the position or the organization more generally. Once a set of qualified applications are assembled, the hiring staff may then further review these candidates and identify those they want to interview.

Initial interviews typically begin with phone calls with HR representatives. Phone interviews determine if the applicant possesses the requisite qualifications to fill the position and align with an organization's culture and values. Phone interviews also enable organizations to further pare down the list of candidates while expending company resources efficiently. Depending on the size of the organization and hiring committee, one or several interviews are then scheduled for those remaining candidates. Interviews may include one-on-one, in-person interviews between the applicants and the hiring manager. One-on-one interview conversations typically focus on applicants' experience, skills, work history, and availability. Additional interviews with management, staff, executives, and other members of the organization may also be performed. They may be formal or casual, on-site, off-site, or video conference, etc. Additional interviews are often more in-depth. For example, each member of the hiring team interviewer may focus on a specific topic or aspect of the job to avoid redundancy and ensure an in-depth conversation about the role and the candidate's qualifications and experience. In some cases, a final interview may also be scheduled with the company's senior leadership. Final interviews are typically extended only to a very small pool of top candidates.

Once the interviews are complete, or during their completion, organizations often assign applicants one or more standardized assessment tests. These exams measure a wide range of variables, including personality traits, problem-solving ability, reasoning, reading comprehension, emotional intelligence, and more.

As such, in the hiring process, various data related to each candidate is generated. Due to the variety and amount of data generated, it is difficult to organize and store such data into a data structure that can be systematically evaluated. It is often that the decision of hiring or not hiring is based on decision-makers' intuitions, lacking objective standards.

The subject matter claimed herein is not limited to embodiments that solve any disadvantages or that operate only in environments such as those described above. Rather, this background is only provided to illustrate one exemplary technology area where some embodiments described herein may be practiced. Finally, background and reference checks may be performed. After the background and reference checks, the hiring staff may make its final decision.

### BRIEF SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

The embodiments described herein are related to storing and organizing pre-hiring screening data of multiple candidates in a task-specific data structure and generating weighted scores using different weights for determining each of the plurality of candidates' fitness to a particular task. The task-specific data structure includes a task step table that stores multiple task steps. Each of the multiple task steps includes one or more step activities. Each of the one or more step activity corresponds to either (1) one or more questions, or (2) one or more assessments.

The task-specific data structure may be accessed by a computing system. For each step activity that corresponds to one or more questions, the computing system records one or more attribute scores for each of the one or more questions. Each of the one or more question attribute scores is associated with an attribute and assigned a question weight. The attribute is selected from a plurality of attributes. For each question, each of the one or more question attribute scores is weighted based on the corresponding question weight. The weighted question attribute scores are then aggregated to generate a question score.

For each step activity that corresponds to one or more assessments, for each of one or more assessments, a set of data related to the assessment is received. One or more assessment attribute scores are then determined based on the corresponding set of data. Each of the assessment attribute scores is also associated with an attribute and assigned an assessment weight. Each of the one or more assessment attribute scores may also be weighted based on the corresponding assessment weights. The weighted one or more assessment attribute scores may also be aggregated to generate an overall assessment score.

Further, each of the questions may further be assigned a second question weight, and each of the assessments may further be assigned a second attribute weight. For each step activity that is associated with one or more questions, each of the questions may be weighted based on the second question weight. The weighted question scores may then be aggregated to generate an overall step activity score. Similarly, for each step activity that is associated with one or more assessments, each of the assessment scores may further be weighted based on the second assessment weight. The weighted assessment scores may also be aggregated to generate an overall step activity score.

In some embodiments, each of the plurality of step activities may be assigned an activity weight. Each step activity score may further be weighted based on the corresponding activity weight. The weighted step activity scores may then be aggregated to generate an overall task step score, which indicates how well a candidate may be able to perform a particular task step. In some embodiments, when a task step score of a particular task step is lower than a predetermined threshold, it is automatically determined that the corresponding candidate is not a qualified candidate. In some embodiments, a visualization may be generated to display each task step score of a particular candidate.

In some embodiments, each of the question attribute scores and each of the assessment scores may further be assigned an attribute weight. For each of the plurality of attributes, each of the one or more question attribute scores and one or more assessment attribute scores are weighted based on the respective attribute weights. The weighted question assessment scores and the weighted assessment attribute scores are then aggregated to generate an overall attribute score that corresponds to the corresponding attribute.

In some embodiments, each of the plurality of attributes may further be assigned a second attribute weight. Additionally, the plurality of attributes may be divided into one or more groups. Each of the one or more groups includes at least one attribute. For each of the one or more groups, each overall attribute score of the at least one attribute contained in the group may further be weighted based on the corresponding second attribute weight. The weighted overall attribute scores may then be aggregated to generate an attribute group score.

Further, each of the one or more groups may also be assigned an attribute group weight. Each attribute group score may further be weighted based on the attribute group weight. The weighted attribute group scores may then be aggregated to generate an overall task score. In some embodiments, a visualization may be generated to display the overall task sore, each of the attribute group scores, and/or each of the overall attribute scores.

In some embodiments, a subset of the multiple candidates are hired to become one or more employees. For each of the one or more employees, a performance score may be received. The performance score indicates the overall post-hiring performance of the corresponding employee. The pre-hiring question scores and the pre-hiring attribute scores of each employee may be analyzed with the performance score of the corresponding employee.

For each question score, a level of correlation of the corresponding question score to the performance score may be determined. In response to a determination that a level of correlation of a question is lower than a predetermined threshold, the question may be removed from the task-specific data structure, or the question weight of the corresponding question may be reduced in the task-specific data structure. A visualization may also be generated to display the level of correlation of each of the question scores to the performance scores.

Similarly, for each overall attribute score, a level of correlation of the corresponding overall attribute score to the performance score may also be determined. In response to a determination that a level of correlation of an attribute score is lower than a predetermined threshold, the attribute may be removed from the task-specific data structure. Alternatively, the attribute weight of the corresponding attribute may be reduced. In response to a determination that a level of correlation of an attribute score is greater than a predetermined threshold, an attribute weight of the corresponding attribute may be increased in the task-specific data structure. A visualization may also be generated to display the level of correlation of each of the overall attributes scores to the performance scores.

The principles described herein allow multiple attributes to be scored on a single interview question or a single assessment, allow applicant questions, applicant assessments, and interview questions to all be combined into a single data structure for thorough scoring, and allow consistent scoring of attributes with fixed scoring criteria per attribute per question, such that the screening scores may be obtained more objectively, more accurately, more efficiently, and more consistently.

Further, the principles described herein not only allow the pre-hiring screening data to be stored and organized, but also allow the employee's post-hiring performance score to be analyzed with the various assessment scores determined during the pre-hiring screening process and allow adaptive improving the pre-hiring screening process by removing or reducing the weight of the less relevant questions and/or attribute from the existing pre-hiring assessment process and/or increasing the weight of the more relevant questions and/or attributes in the pre-hiring assessment process.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and details through the use of the accompanying drawings in which:

FIG. 1A illustrates an example task-specific data structure for storing and organizing pre-hiring screening data of multiple candidates;

FIG. 1B illustrates an example first portion of the task-specific data structure that may be used to record task steps and task step activities;

FIG. 1C illustrates an example relational model diagram of a task table, task step table and step activity table, which may form the first portion of the task-specific data structure;

FIG. 1D illustrates an example second portion of the task-specific data structure that may be used to store task steps, step activities, questions, and assessments;

FIG. 1E illustrates an example relational model diagram of a step activity table, a question table, a question attribute table, an assessment table, and an assessment attribute table;

FIG. 2 illustrates an example data structure for storing and organizing data related to task attribute group and attributes;

FIG. 3 illustrates an example data structure for storing data related to an assessment;

FIG. 4A illustrates an example table report including different attribute scores generated for a particular candidate;

FIG. 4B illustrates an example table report including different question attribute scores generated for a particular candidate;

FIG. 5A illustrates an example table report showing correlations between employees' multiple attribute scores and their overall performance;

FIG. 5B illustrates an example dot graph showing the correlation between a particular attribute score and the overall performance of employees;

FIG. 5C illustrates an example table report showing correlations between employees' multiple question attribute scores and their overall performance;

FIG. 5D illustrates an example dot graph showing the correlation between a particular question attribute score and the overall performance of employees;

FIGS. 6A, 6B, 6C, and 6D illustrate a flow chart of an example method for recording and organizing pre-hiring screening data of multiple candidates in a task-specific data structure and generating weighted scores using different weights for determining each of the multiple candidates' fitness to a particular task; and

FIG. 7 illustrates an example computing system in which the principles described herein may be employed.

### DETAILED DESCRIPTION

The embodiments described herein are related to storing and organizing pre-hiring screening data of multiple candidates in a task-specific data structure and generating weighted scores using different weights for determining each of the plurality of candidates' fitness to a particular task. The task-specific data structure includes a task step table that stores multiple task steps. Each of the multiple task steps includes one or more step activities. Each of the one or more step activity corresponds to either (1) one or more questions, or (2) one or more assessments.

The task-specific data structure may be accessed by a computing system. For each step activity that corresponds to one or more questions, the computing system records one or more attribute scores for each of the one or more questions. Each of the one or more question attribute scores is associated with an attribute and assigned a question weight. The attribute is selected from a plurality of attributes. For each question, each of the one or more question attribute scores is weighted based on the corresponding question weight. The weighted question attribute scores are then aggregated to generate a question score.

For each step activity that corresponds to one or more assessments, for each of one or more assessments, a set of data related to the assessment is received. One or more assessment attribute scores are then determined based on the corresponding set of data. Each of the assessment attribute scores is also associated with an attribute and assigned an assessment weight. Each of the one or more assessment attribute scores may also be weighted based on the corresponding assessment weights. The weighted one or more assessment attribute scores may also be aggregated to generate an overall assessment score.

Further, each of the questions may further be assigned a second question weight, and each of the assessments may further be assigned a second attribute weight. For each step activity that is associated with one or more questions, each of the questions may be weighted based on the second question weight. The weighted question scores may then be aggregated to generate an overall step activity score. Similarly, for each step activity that is associated with one or more assessments, each of the assessment scores may further be weighted based on the second assessment weight. The weighted assessment scores may also be aggregated to generate an overall step activity score.

In some embodiments, each of the plurality of step activities may be assigned an activity weight. Each step activity score may further be weighted based on the corresponding activity weight. The weighted step activity scores may then be aggregated to generate an overall task step score, which indicates how well a candidate may be able to perform a particular task step. In some embodiments, when a task step score of a particular task step is lower than a predetermined threshold, it is automatically determined that the corresponding candidate is not a qualified candidate. In some embodiments, a visualization may be generated to display each task step score of a particular candidate.

In some embodiments, each of the question attribute scores and each of the assessment scores may further be assigned an attribute weight. For each of the plurality of attributes, each of the one or more question attribute scores and one or more assessment attribute scores are weighted based on the respective attribute weights. The weighted question assessment scores and the weighted assessment attribute scores are then aggregated to generate an overall attribute score that corresponds to the corresponding attribute.

In some embodiments, each of the plurality of attributes may further be assigned a second attribute weight. Additionally, the plurality of attributes may be divided into one or more groups. Each of the one or more groups includes at least one attribute. For each of the one or more groups, each overall attribute score of the at least one attribute contained in the group may further be weighted based on the corresponding second attribute weight. The weighted overall attribute scores may then be aggregated to generate an attribute group score.

Further, each of the one or more groups may also be assigned an attribute group weight. Each attribute group score may further be weighted based on the attribute group weight. The weighted attribute group scores may then be aggregated to generate an overall task score. In some embodiments, a visualization may be generated to display the overall task sore, each of the attribute group scores, and/or each of the overall attribute scores.

In some embodiments, a subset of the multiple candidates are hired to become one or more employees. For each of the one or more employees, a performance score may be received. The performance score indicates the overall post-hiring performance of the corresponding employee. The pre-hiring question scores and the pre-hiring attribute scores of each employee may be analyzed with the performance score of the corresponding employee.

For each question score, a level of correlation of the corresponding question score to the performance score may be determined. In response to a determination that a level of correlation of a question is lower than a predetermined threshold, the question may be removed from the task-specific data structure, or the question weight of the corresponding question may be reduced in the task-specific data structure. A visualization may also be generated to display the level of correlation of each of the question scores to the performance scores.

Similarly, for each overall attribute score, a level of correlation of the corresponding overall attribute score to the performance score may also be determined. In response to a determination that a level of correlation of an attribute score is lower than a predetermined threshold, the attribute may be removed from the task-specific data structure. Alternatively, the attribute weight of the corresponding attribute may be reduced. In response to a determination that a level of correlation of an attribute score is greater than a predetermined threshold, an attribute weight of the corresponding attribute may be increased in the task-specific data structure. A visualization may also be generated to display the level of correlation of each of the overall attributes scores to the performance scores.

The principles described herein allow multiple attributes to be scored on a single interview question or a single assessment, allow applicant questions, applicant assessments, and interview questions to all be combined into a single data structure for thorough scoring, and allow consistent scoring of attributes with fixed scoring criteria per attribute per question, such that the screening scores may be obtained more objectively, more accurately, more efficiently, and more consistently.

Further, the principles described herein not only allow the pre-hiring screening data to be stored and organized, but also allow the employee's post-hiring performance score to be analyzed with the various assessment scores determined during the pre-hiring screening process and allow adaptive improving the pre-hiring screening process by removing or reducing the weight of the less relevant questions and/or attribute from the existing pre-hiring assessment process and/or increasing the weight of the more relevant questions and/or attributes in the pre-hiring assessment process.

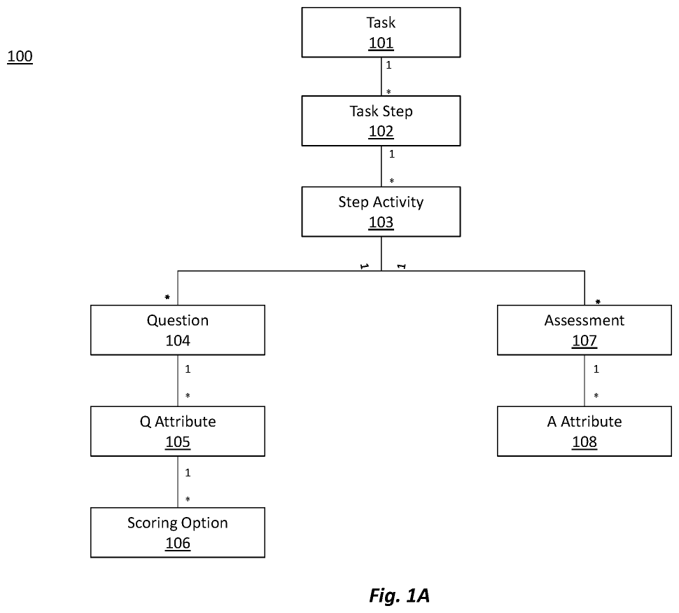

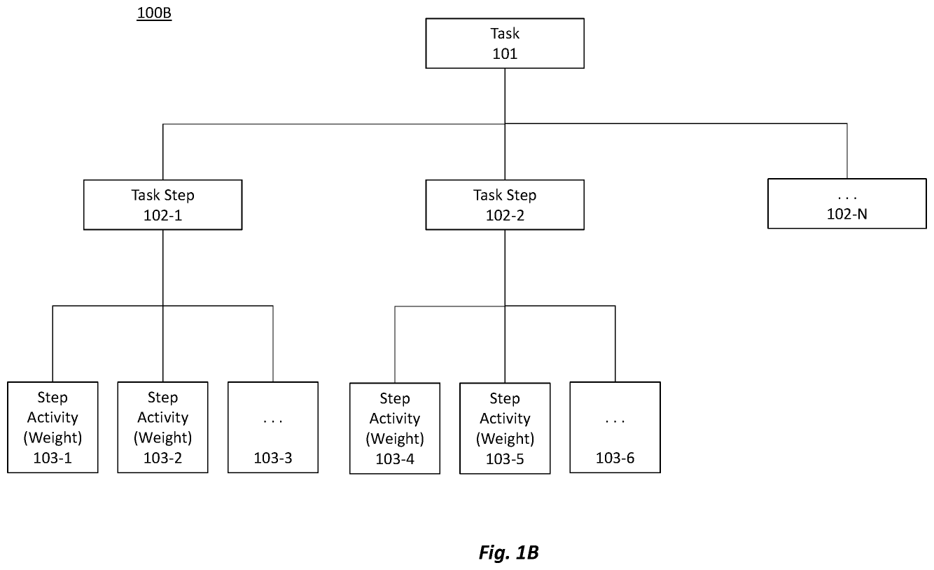

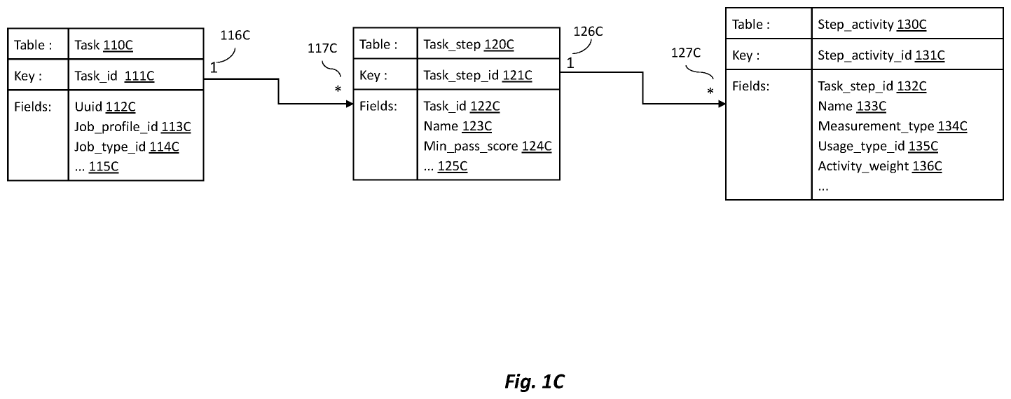

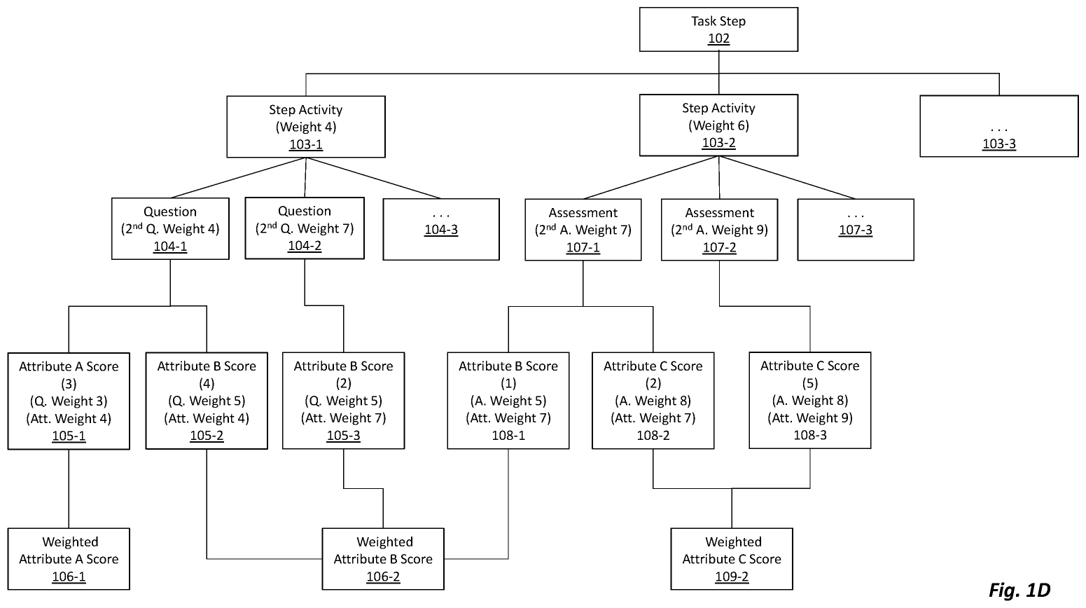

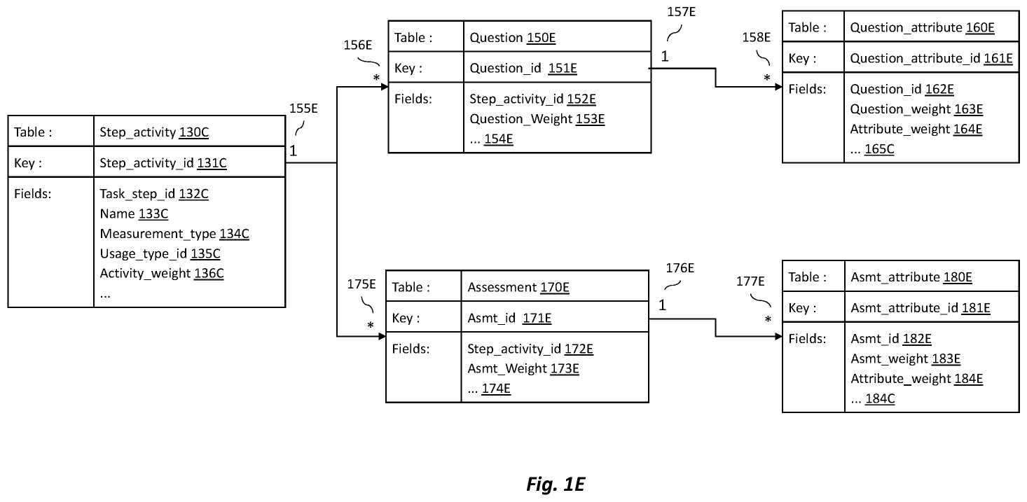

Further details related to example embodiments are described with respect to FIGS. 1 through 11. FIG. 1A illustrates an example task-specific data structure 100 that may be used to store pre-hiring screening data of multiple candidates. The data structure 100 may be specific to a particular task 101. The task 101 includes one or more task steps 102. Each of the task steps 102 includes one or more task step activities 103. Each of the task step activities 103 corresponds either (1) one or more question 104, or (2) one or more assessments 107. Each of one or more questions 104 is associated with one or more question attributes 105, and each of one or more assessments 107 is associated with one or more assessment attributes 108. Various score options 106 may be implemented at each question attributes 105. In some embodiments, each of the one or more question attributes 105 may be individually scored. Alternatively, each question may be scored as a whole.

FIG. 1B further illustrates the first portion 100B of the task-specific data structure 100 that records the task steps 102 and task step activities 103. As illustrated in FIG. 1B, each task 101 may be divided into one or more task steps 102-1, 102-2. The ellipsis 102-N represents that there may be any natural number of task steps in the task 101. Each of the task steps 102-1 and 102-2 may be further divided into one or more task step activities 103-1 through 103-6. For example, the task step 102-1 may be divided into task step activities 103-1 and 103-2, and the task step 102-2 may be divided into task step activities 103-4 and 103-5. Each of the ellipsis 103-3 or 103-6 represents that there may be any number of task step activities in each of the task step 102-1 or task step 102-2.

Further, each of the task step activities 103-1 through 103-6 may be assigned a step activity weight that indicates the importance of the corresponding activity within the task step. For example, the most important step activity may be assigned a weight as 10, the least important step activity may be assigned a weight as 1.

In a database system, each of the task 101, task steps 102, and step activities 103 may be recorded in a separate table. Each of these tables may be joined by table IDs, such that the data related to each task step activities, task step, and task are stored relationally in a task-specific data structure. FIG. 1C further illustrates an example relational model diagram of the task table 110C, task step table 120C and step activity table 130C.

As illustrated in FIG. 1C, the task table 110C may include a Task_id 111C as its primary key. The task table 110C may also include one or more additional fields, such as a universal unique identifier field 112C, a job profile ID field 113C, and a job type id field 114C. The ellipsis 115C represents that there may be additional or any number of fields contained in the task table 110C. Each of the task 110C may correspond to any number of task steps 120C, which is represented by the number “1” symbol 116C and the “*” symbol 117C. The task_step table 120C joins the task table 110C by the task id 111C, 122C.

The task step table 120C may include a task step ID 121C as its primary key. The task step table 120C may also include one or more additional fields, such as a task ID field 122C (which is used to join the task step table 120C to the task table 110C), a name field 123C, and a minimum passing score field 124C. The ellipsis 125C represents that there may be additional or any number of fields contained in the task_step table 120C. The name field 123C may specify the name of the task step 120C, and the minimum passing score field 124C may specify a minimum passing score for a candidate to be further considered. The data structure 100 may allow an overall score to be generated for each task step. When the overall score of the task step is below the minimum passing score, the candidate may be automatically eliminated for further consideration. Additional details about how the overall score of a particular task step may be generated will be described later with respect to FIG. 1D.

Further, each of the task steps recorded in the task step table 120C may correspond to any number of step activities recorded in step activity table 130C, which is represented by the number “1” symbol 126C and the “*” symbol 127C. The step activity table 130C joins the task step table 120C by the task_step_id 121C, 132C. The step_activity table 130C may include a step activity ID 131C as its primary key. The step activity table 130C may also include one or more additional fields, such as a task step ID field 132C (which is used to join the step activity table 130C to the table task step 120C), a name field 113C, a measurement type field 134C, a usage type ID field 135C, and an activity weight field 136C. The name field 133C may be used to specify the name of the step activity. The measurement type field 134C and usage type ID field 135C may be used to describe or identify the measurement type and usage type of the step activity. The activity weight field 136C indicates the importance of the step activity within the task step. For example, the data structure 100 may allow a step activity score to be generated for each step activity. Based on the activity weight, each of the step activity scores may be aggregated to generate an overall task step score. The ellipsis 137C represents that there may be additional or any number of fields contained in the step activity table 130C.

FIG. 1D further illustrates an example of a second portion of the data structure 100. As illustrated in FIG. 1D, each task step 102 may include one or more step activities 103-1 and 103-2. The ellipsis 103-3 represents that there may be any number of step activities contained in each task step 102. Further, each of the step activities 103-1 and 103-2 may correspond to either (1) one or more questions, or (2) one or more assessments. A question may simply be a yes or no question, or a question asking the candidate to evaluate himself/herself about his/her ability to perform a particular task step. For example, the task step may be playing basketball, and the questions may include (1) how good are you at basketball, (2) how high can you jump, and (3) how good are you at dribbling. In some embodiments, based on the answer to the questions, the system may generate an overall score of the question. Alternatively, or in addition, based on the answer to the question, the system may generate multiple scores for the same question, and each of the scores may correspond to a particular attribute.

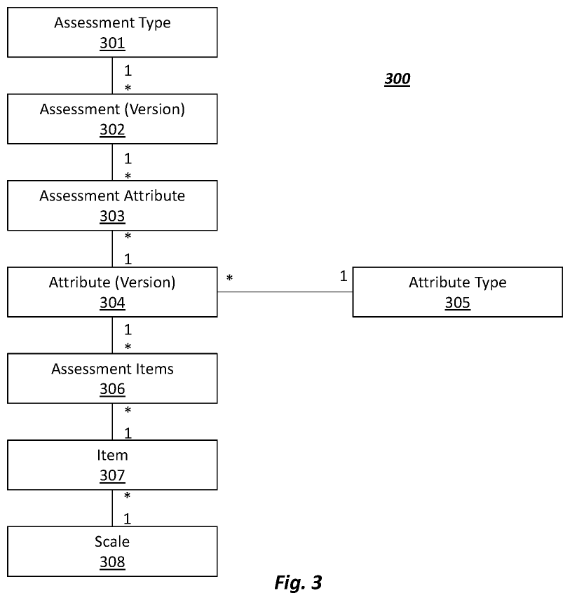

As described above, some step activities may correspond to one or more assessments. An assessment is more complex than a question. For example, an assessment may include a set of various data items that are used to perform a psychometric assessment. Based on the set of data generated by the assessment, the system may also generate one or more scores, each of which may correspond to a particular attribute. Further details about the data model for creating standard or custom assessments will be described later with respect to FIG. 3.

As illustrated in FIG. 1D, the step activity 103-1 corresponds to one or more questions 104-1, 104-2, and the activity 103-2 corresponds to one or more assessments 107-1, 107-2. The ellipsis 104-3 represents that there may be any number of questions that correspond to the step activity 103-1. Similarly, the ellipsis 107-3 represents that there may be any number of assessments that correspond to the step activity 103-2.

The question 104-1 is used to generate a question attribute A score 105-1 and an attribute B score 105-2. The question attribute A score 105-1 is associated with Attribute A, and the question attribute B score 105-2 is associated with attribute B. Question 104-2 is used to generate a question attribute B score 105-3, which is also associated with attribute B. Each of the question attribute scores 105-1, 105-2, and 105-3 is assigned to two weights: (1) a question weight and (2) an attribute weight. The question weight may be used to weight the multiple attribute scores generated for a same question, and the weighted attribute scores may then be aggregated to generate a question score. In general, a weighted aggregated score may be generated based on Equation 1 below:

$$\frac{{\sum }_{i = 1}^{n} ( xi * wi )}{{\sum }_{i = 1}^{n} wi} \qquad Equation 1$$

For example, question attribute A score 105-1 is “3”, and it is assigned a question weight “3”; question attribute B score 105-2 is “4”, and it is assigned a question weight “5”. Accordingly, a question score for question 104-1 may be generated as 3.625=(3×3+4×5)/(3+5).

Further, each of the questions 104-1 and 104-2 may further be assigned to a second question weight. For example, question 104-1 may be assigned a second question weight 4, and question 104-2 may be assigned a second question weight 7. The second question weight for each of the questions 104-1 and 104-2 may be used to weight each of the question scores. As described above, a question score for each question may be generated by weighing and aggregating the question attribute scores. These question scores may further be weighted and aggregated to generate an overall step activity score. For example, as described above, the question score for question 104-1 may be 3.625. Since question 104-2 only has one attribute score 105-3, the overall question score for question 104-2 would be the same as the attribute score 105-3, i.e. “2”. As illustrated in FIG. 1D, the second question weight for question 104-1 is 4, and the second question weight for question 104-2 is 7. Accordingly, the overall step activity score for step 103-1 may be generated as 2.59=(3.625×4 +2×7)/(4+7).

Similarly, assessment 107-1 is used to generate an assessment attribute B score 108-1 and an assessment attribute C score 108-2, and assessment 107-2 is used to generate an assessment attribute C score 108-3. Each of the attribute scores 108-1, 108-2, and 108-3 is associated with the corresponding attribute, and also assigned two weights: (1) an assessment weight, and (2) an attribute weight. The assessment weight may also be used to weight the multiple assessment attribute scores generated for a same assessment, and the weighted assessment attribute scores may then be aggregated to generate an assessment score. For example, assessment attribute B score 108-1 is “1”, and it is assigned an assessment weight “5”, and assessment attribute C score 108-2 is “2”, and it is assigned an assessment weight 8. Accordingly, an assessment score for assessment 107-1 may be generated as 1.61=(1×5+2×8)/(5+8).

Further, each of the assessments 107-1 and 107-2 may also be assigned a second assessment weight. The second assessment weight may be used to weight and aggregate each of the assessment scores to generate an overall step activity score. As discussed above, the assessment score for assessment 107-1 may be 1.61. Since assessment 107-2 only has one attribute score 108-3, the assessment score for assessment 107-2 would be the same as the attribute score 108-3, i.e. “5”. Further, as illustrated in FIG. 1D, the assessment 107-1 is associated with a second assessment weight 7, and the assessment 107-2 is associated with a second assessment weight 9. Accordingly, the overall step activity score for step 103-2 may be generated as 3.51=(1.61×7+5×9)/(7+9).

Further, each of the step activities 103-1 and 103-2 may also be assigned a step activity weight. For example, step activity 103-1 may be assigned a weight “4”, and step activity 103-2 may be assigned a weight “6”. The overall step activity scores corresponding to each of the step activities 103-1 and 103-2 may also be weighted and aggregated to generate an overall task step score. As discussed above, step activity 103-1 may be associated with a step activity sore of 2.59, and step activity 103-2 may be associated with a step activity score of 3.51. As such, the overall task step score corresponding to task step 102 may be generated as 3.142=(2.59×4+3.51×6)/(4+6).

In the data system, similar to the task table 110C, task step table 120C, and step activity table 130C illustrated in FIG. 1C, each of the questions 104, assessments 107, and question attributes 105 and assessment attributes 108 may also be recorded in a separate table. Each of these tables may also be joined by table IDs, such that the data related to each of the questions, assessments, and attributes are also stored relationally in the task-specific data structure. FIG. 1E further illustrates an example relational model diagram of the step activity table 130C, question table 150E, question attribute table 160E, assessment table 170E and assessment attribute table 180E.

As illustrated in FIG. 1E, each of the question table 150E or assessment table 170E may be joined to the step activity table 130C by the step activity ID 131C, 152E, and 172E. Each step activity table 130C may correspond to either (1) any number of questions or (2) any number of assessments, which is represented by the number “1” symbol 155E and the “*” symbols 156E and 175E.

The question table 150E may include a question ID 151E as its primary key. The question table 150E may also include one or more additional fields, such as the step activity ID 152E (which is used to join the question table 150E to the step activity table 130C) and a question weight 153E, which may correspond to the second question weight discussed with respect to FIG. 1D. The question weight 153E indicates the importance of the question with respect to the step activity. The ellipsis 154E represents that there may be additional or any number of fields contained in the question table 150E. The question table 150E may further join a question attribute table 160E by the question ID 151E and 162E. Each question recorded in the question table 150E may correspond to any number of question attributes recorded in the question attribute table 160E, which is represented by the number “1” symbol 157E and the “*” symbol 158E.

The question attribute table 160E may include a question attribute ID 161E as its primary key. The question attribute table 160E may also include one or more additional fields, such as a question ID field 162E (which is used to join the attribute table 160E to the question table 150E), a question weight field 163E and an attribute weight field 164E. The question weight field 163E and the attribute weight field 164E may correspond to the question weight and attribute weight discussed with respect to FIG. 1D.

Similarly, the assessment table 170E may include an assessment ID 171E as its primary key. The question table 170E may also include one or more additional fields, such as the step activity ID 172E (which is used to join the assessment table 170E to the step activity table 130C) and an assessment weight 173E, which may correspond the second assessment weight discussed with respect to FIG. 1D. The assessment weight 173E indicates the importance of the assessment with respect to the step activity. The ellipsis 174E represents that there may be additional or any number of fields contained in the assessment table 170E. The assessment table 170E may further join an assessment attribute table 180E by the assessment ID 171E, 182E. Each assessment may correspond to any number of assessment attributes, which is represented by the number “1” symbol 176E and the “*” symbol 177E.

The assessment attribute table 180E may include an assessment attribute ID 181E as its primary key. The assessment attribute table 180E may also include one or more additional fields, such as an assessment ID field 182E (which is used to join the assessment attribute table 180E to the assessment table 170E), an assessment weight field 183E, and an attribute weight field 184E. The assessment weight field 183E and the attribute weight field 184E may correspond to the assessment weight and the attribute weight discussed with respect to FIG. 1D.

On the other side, the data structure illustrated in FIG. 1D not only is capable of generating aggregated question scores, step activity scores, and task step scores, but also capable of generating aggregated attribute scores. Referring back to FIG. 1D, each of the question attribute scores 105-1, 105-2 and assessment attribute scores 108-1, 108-2 may also be weighted based on their respective second attribute weight, which may correspond to attribute weight fields 164E and 184E. The weighted question attribute scores 105-1, 105-2 and assessment attribute scores 108-1, 108-2 may then be aggregated to generate an overall attribute score.

For example, there are several attribute B scores 105-2, 105-3, and 108-1 are generated from the questions 104-1, 104-2 in step activity 103-1 and the assessments 107-1, 107-2 in step activity 103-2. In particular, question attribute B score 105-2 is 4, and it has an attribute weight 4; question attribute B score 105-3 is 2, and it has an attribute weight 7; and assessment attribute B score 108-1 is 1, and it has an attribute weight 7. Accordingly, an overall attribute score for attribute B may be generated as 2.05=(4×4+2×7+1×7)/(4+7+7). As such, for each attribute, an overall attribute score may be generated. For example, an overall attribute score may also be generated for attribute A and/or attribute C.

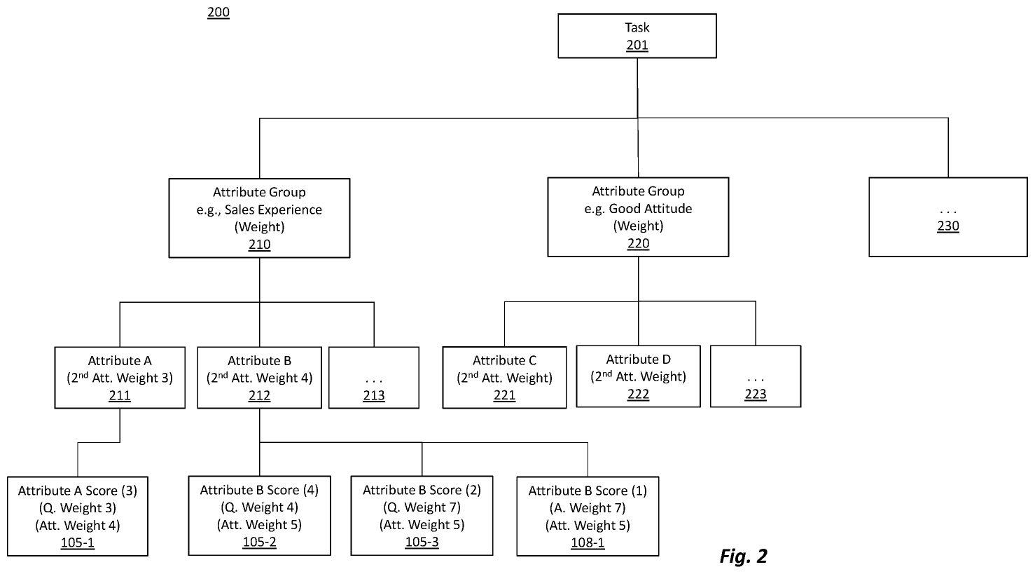

In some embodiments, each of the multiple attributes may further be assigned a second attribute weight. Additionally, the multiple attributes may further be grouped into attribute groups. The attributes contained in each group may further be weighted and aggregated to generate an attribute group score. Each of the attribute groups may also be assigned an attribute group weight. Each of the attribute group scores may further be weighted and aggregated into a overall task score. Further details related to the data structure storing attributes will be discussed with respect to FIG. 2.

As described above, the specific task 101 may require the employees to possess various attributes. Another portion of the task-specific data structure is to record and organize these attributes. FIG. 2 illustrates an example data structure 200 for recording and organizing various attributes. As illustrated in FIG. 2, the task 201 may correspond to one or more task attribute groups 210 and 220. For example, task attribute group 210 may correspond to one or more attributes 211 and 212, each of which may be related to sales experience, and task attribute group 220 may correspond to one or more attributes 221 and 222, each of which may be related to a good attitude. The ellipsis 230 represents that there may be any number of task attribute groups corresponding to the task 201. The ellipsis 213 or 223 represents that there may be any number of attributes within the attribute group 210 or 220. Each of the attributes 211-212, 221-222 may be associated with a second attribute weight, and each of the task attribute groups may further be associated with an attribute group weight.

As illustrated in FIG. 1D, the system may generate a weighted attribute score for each attribute. Each of these attributes may then be weighted based on their respective second attribute weights to generate an overall task attribute group score. For example, attribute B scores 105-2, 105-3, and 108-1 of FIG. 1D may be weighted and aggregated based on their respective attribute weights to generate an overall attribute B score 106-2. The overall attribute B score 106-2 (e.g., 2.05)of FIG. 1D may correspond to attribute B 212 of FIG. 2. Similarly, the overall attribute A score 106-1 (e.g., “3”) may correspond to attribute A 211 of FIG. 2. The attribute group 210 includes attribute A 211 and attribute B 212, each of which is assigned a respective second attribute weight 3 and 4. As such, the overall attribute group score for attribute group 210 may be generated as 2.45=(3×3+2.05×4)/(3+4).

Further, each of the task attribute group scores may then be weighted to generate an overall score for the task 201. As such, an overall score for the task 201, 101 or a task step 102 may be diversely generated based on each task steps and/or based on each attribute. A minimum passing score may be set for each task step, for each attribute, and/or for the overall score for the task depending on the organization's needs.

As briefly discussed above, an assessment is more complex than a question. An assessment includes a set of various data items. FIG. 3 further illustrates an example data structure 300 for storing and connecting various data items of an assessment. As illustrated in FIG. 3, an assessment may include an assessment type 301, which corresponds to one or more different versions of assessments 302. Each version of the assessment may correspond to one or more assessment attributes 303. Each of the assessment attributes 303 belongs to a version of the attribute 304, which may, in turn, belong to an attribute type 305. Further, each version of the attribute 304 may include one or more assessment items 306. Each of the assessment items 306 may belong to an item 307, and each of the items 307 may further belong to a scale 308.

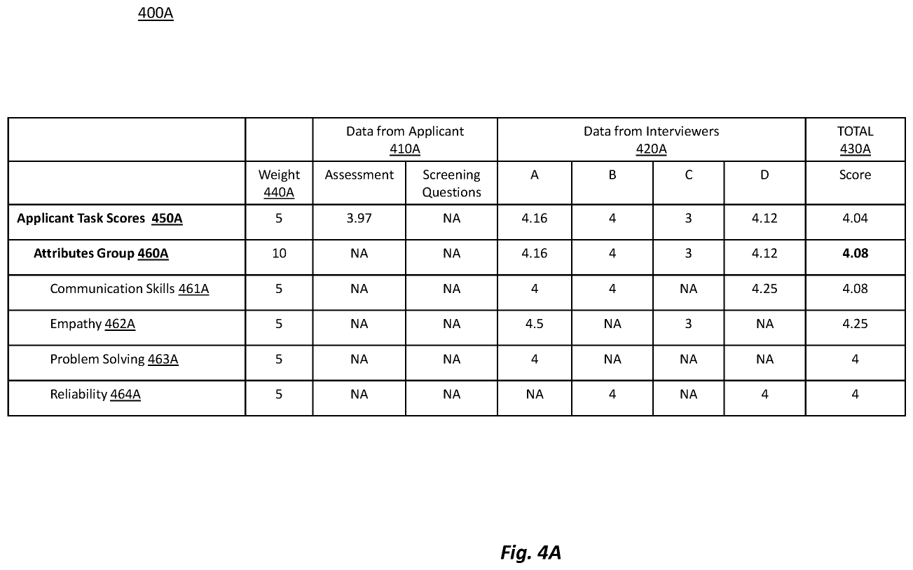

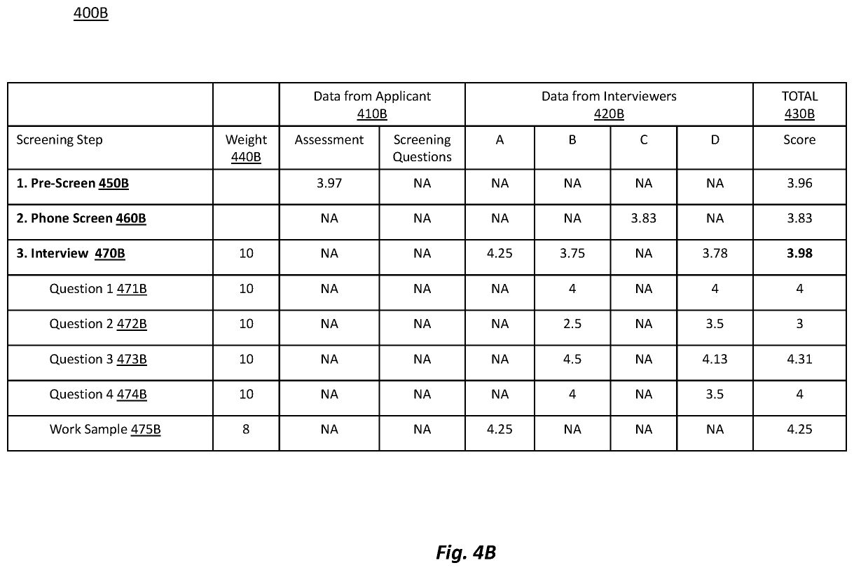

The above described task-specific data structure 100, 200, and/or 300 not only allow the computing system to diversely generate weighted scores in multiple dimensions, but also allow the computing system to generate various reports, charts, and or visualizations to show the screening results of each candidate. FIGS. 4A and 4B illustrate the example reports generated for a particular candidate. For example, FIG. 4A shows a table report 400A that includes different attribute scores of a particular applicant (i.e., candidate) obtained through different steps of the screening process. The columns 410A include data obtained from the applicant, the columns 420A include data obtained from different interviewers A through D, and column 430A includes the aggregated data obtained from both the applicant and different interviewers. The rows 461A through 464A include various attribute scores generated for the applicant based on the assessment or based on the interview with four different interviewers. Each of the attributes 461-464A is associated with a weight recorded in column 440A. The row 460A includes attribute group scores generated by weighting and aggregating each of the attributes scores in rows 461A through 464A based on their respective attribute weights. The group attribute 460A is also associated with a group attribute weight “10”. The row 450A includes the overall task score generated by weighting and aggregating each of the attribute group scores 450A.

FIG. 4B shows a table report 400B that includes different question scores of a particular applicant (i.e., candidate) obtained through different steps of the screening process. The columns 410B include data obtained from the applicant, the columns 420B include data obtained from different interviewers A through D, and column 430B includes the aggregated data obtained from both the applicant and different interviewers. The row 450B includes data obtained from the pre-screen process, which may be an online assessment completed by the applicant remotely. The row 460B includes data obtained from the phone screen process, which may be a phone interview conducted by interviewer C. The rows 470B, 471B through 475B include data obtained via an in-person interview. The interview includes questions 1 through 4 and a work sample. Each of the questions and the work sample is assigned a weight shown in column 440B. Based on the applicant's answer to each of the questions 471B through 474B and the work sample 475B, the interviewers A-D provided a score for the applicant. These scores are then weighted based on the assigned weight to generate an aggregated average score shown in column 430B.

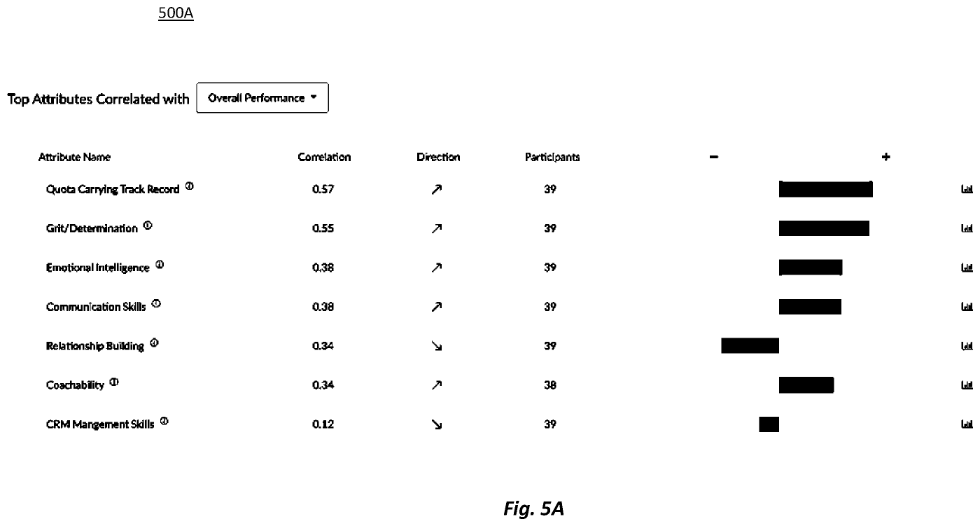

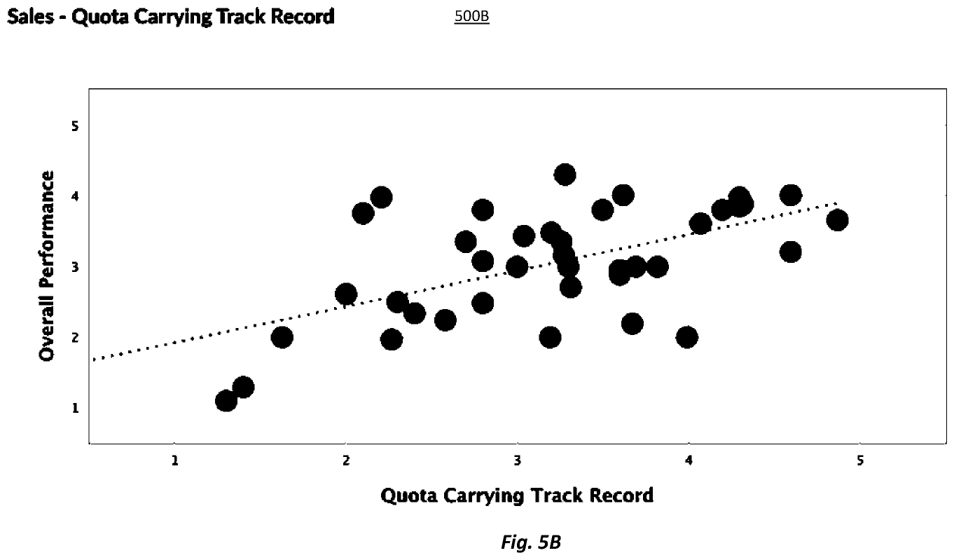

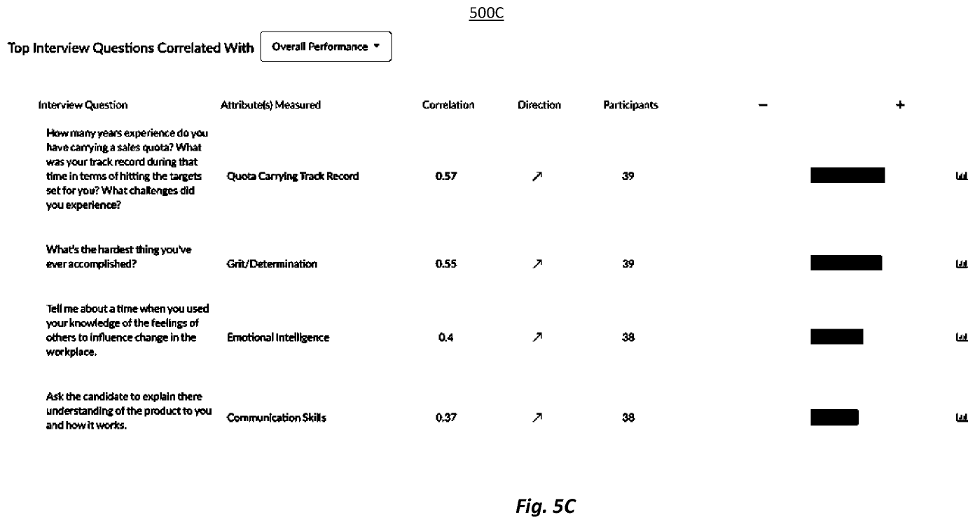

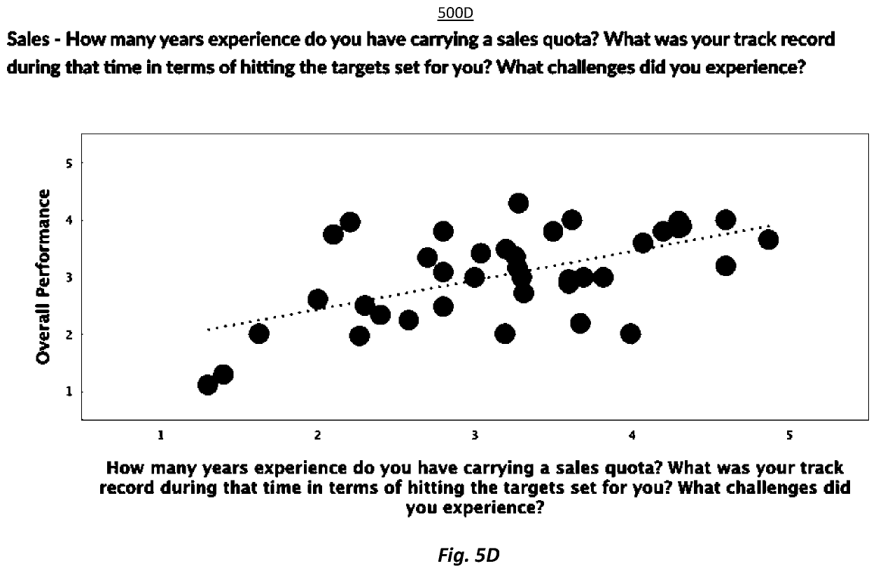

Finally, some of the candidates are eventually hired to become the employees of the organization. For these hired employees, their pre-hiring screening data may be analyzed with their overall performance, such that a correlation between the pre-hiring screening question scores and attribute scores and overall performance may be determined. Based on the analysis, certain less correlated screening questions or attributes may be removed from the future pre-hiring screening process, and certain highly correlated screening questions or attributes may be assigned a higher weight for the future pre-hiring screening process. FIGS. 5A-5D illustrate various example reports generated by comparing the employees' pre-hiring screening data with their overall performance.

FIG. 5A illustrates a table report 500A that shows the correlation between employees' overall performance and each of the attributes assessed during the pre-screening process. For example, the quota-carrying track record has the highest correlation 0.57, and relationship building and CRM management skills have a negative correlation to the overall performance. As such, the system may remove relationship building and CRM management skills from the task-specific data structure 100 and/or 200, such that in the future, these attributes will not be screened for this specific task or job screening process.

FIG. 5B illustrates a graph report that shows a dot graph 500B. The X-axis represents the quota-carrying track record attribute score of each employee, and the Y-axis represents the overall performance of each employee. The dotted line represents the lineal correlation between the quota-carrying track record score versus the overall performance. For each of the attributes listed in FIG. 5A, a dot graph may be generated to show the linear correlation between the particular attribute and the overall performance.

FIG. 5C illustrates another table report 500C that shows the correlation between employees' overall performance and each of the interview questions. As illustrated in FIG. 5C, the first question “How many years experience do you have carrying a sales quota? . . . ” has the highest correlation 0.57 to the employees' overall performance; and the last question “Ask the candidate to explain their understanding of the product to you and how it works” has the lowest correlation 0.37 to the employees' overall performance. The system may remove the questions that have a correlation lower than a predetermined threshold from the data structure, and may also increase the weight of the questions that have a correlation greater than a predetermined threshold.

FIG. 5D illustrates another graph report that shows a dot graph 500D. The X-axis represents the employee's score corresponding to the question “How many years experience do you have carrying a sales quota? . . . ” The Y-axis represents the employees' overall performance. The dotted line represents the lineal correlation between the question versus the overall performance. For each of the questions listed in FIG. 5C, a similar dot graph may be generated to show the linear correlation between the particular question and the overall performance.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

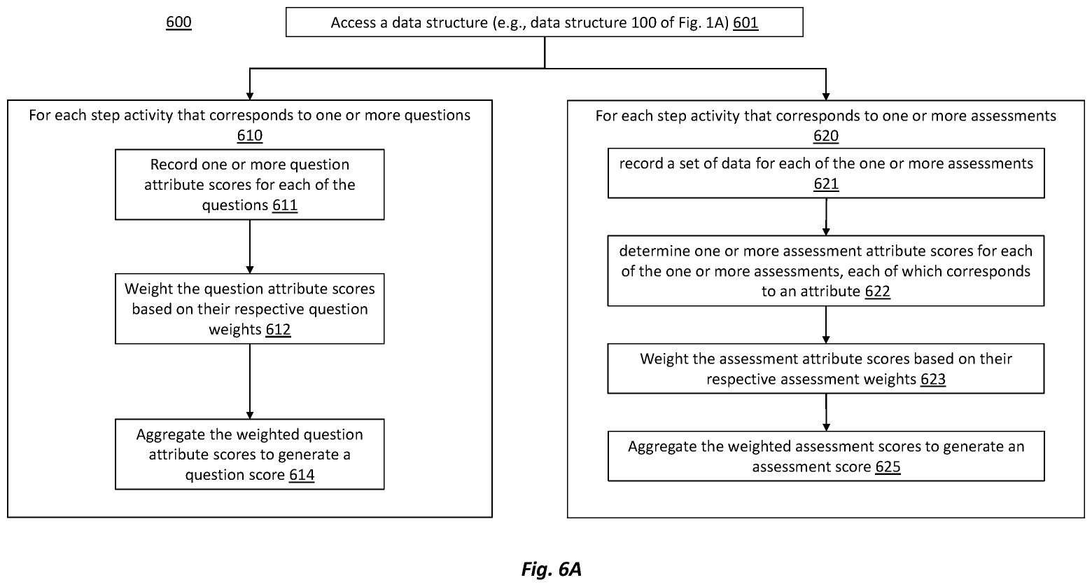

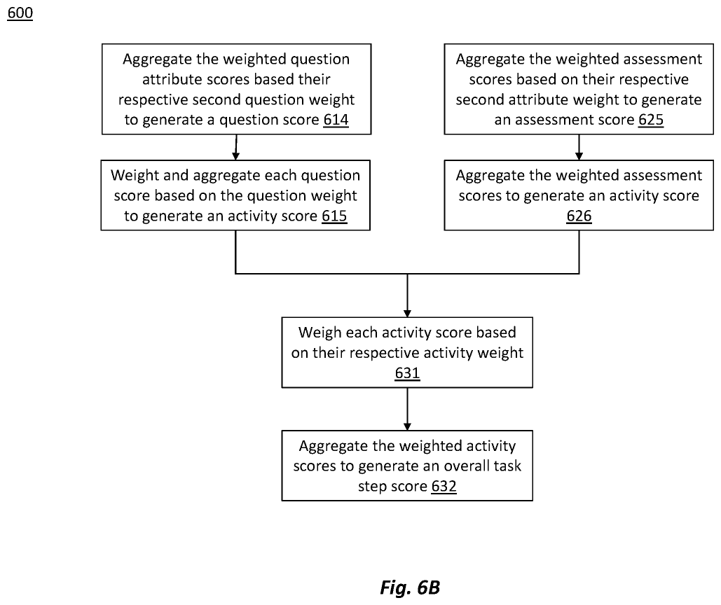

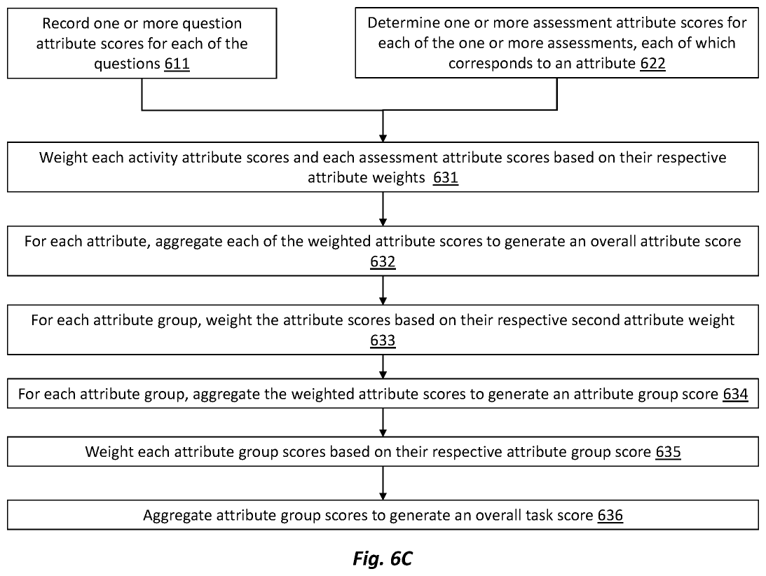

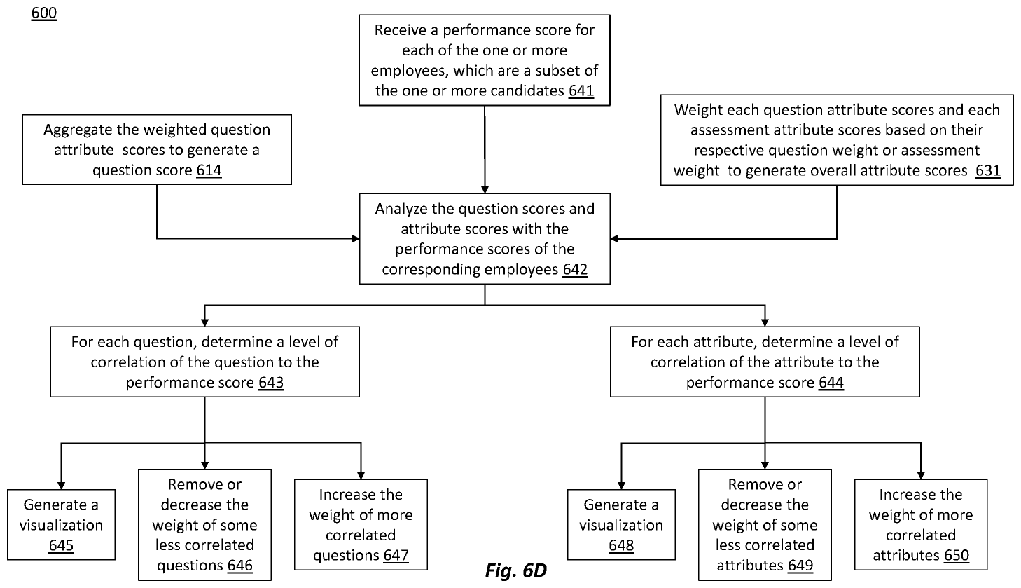

FIGS. 6A, 6B, 6C, and 6D illustrate a continuous flowchart of an example method 600 for recording and organizing pre-hiring screening data of multiple candidates in a task-specific data structure and generating weighted scores using different weights for determining each of the multiple candidates' fitness to a particular task. The method 600 includes accessing a data structure (act 601). The data structure may correspond to the data structure 100 of FIG. 1A. The data structure is structured for storing and processing pre-hiring screening data of multiple candidates. The data structure includes a task step table that stores multiple task steps. Each of the multiple task steps includes one or more step activities. Each of the step activities corresponds to either (1) one or more questions, or (2) one or more assessment. Each of the one or more questions is associated with a question weight, and each of the one or more assessments is associated with an assessment weight.

For each step activity that corresponds to one or more questions (610), one or more question attribute scores are recorded for each of the one or more questions (act 611). Each of the one or more question attribute scores is associated with one of a plurality of attributes. Each of the attribute scores is assigned a question weight. The method 600 further includes for each question, weighing each of the question attribute scores based on their respective question weights (act 612) and aggregating the weighted question attribute scores to generate an overall question score (act 614).

For each step activity that corresponds to one or more assessments (620), a set of data is recorded for each of the one or more assessments (621). The method 600 further includes determining one or more assessment attribute scores for each of the one or more assessments (622). Each of the assessment attribute scores is also associated with one of the plurality of attributes and assigned an assessment weight. Each of the assessment attribute scores is then weighted based on their respective assessment weights (623). The weighted assessment attribute scores are then aggregated to generate an assessment score (625).

FIG. 6B is a continuation of FIG. 6A. Referring to FIG. 6B, each of the questions may also be assigned a second question weight. Each of the question scores may also be weighted by their respective second question weights, and the weighted question scores may then be aggregated to generate an activity score (615). Similarly, each of the assessments may also be assigned a second assessment weight. Each of the assessment scores may also be weighted by their respective second assessment weights, and the weighted assessment scores may also be aggregated to generate an activity score (626).

Further, each of the activities may also be associated with an activity weight. The method 600 may also include weighing each of the activities scores generated via acts 615 and 626 based on their respective activity weights (act 631). Each of the weighted activity scores may then be aggregated to generate an overall task step score (632).

FIG. 6C is a further continuation of FIGS. 6A and 6B. Referring to FIG. 6C, each of the question attribute scores generated via act 611 and assessment attribute scores generated via 622 may further be weighted based on their respective attribute scores (631). For each attribute, the weighted attribute scores may then be aggregated to generate an overall attribute score (632).

Additionally, each of the attributes may further be assigned a second attribute weight. Further, the attributes may further be divided into multiple groups. For each group, each attribute within the group may further be weighted based on their respective second attribute scores (633). The weighted attribute scores within each group may also be aggregated to generate an attribute group score (634). Each of the attribute group scores may also be assigned an attribute group weight, and the attribute group scores may be weighted based on their respective attribute group weights (635). The weighted attribute group scores may then be aggregated to generate an overall task score (636).

FIG. 6D is a further continuation of FIGS. 6A, 6B, and 6C. Referring to FIG. 6D, some of the candidates may be hired to become employees. For each employee, a performance score may be received (act 641). The performance score of each employee is indicative of the employee's overall performance. The pre-hiring question scores obtained from act 614 and the overall attribute scores obtained from act 631 for these employees may further be analyzed with the performance score of the corresponding employees (act 642). For each question, a level of correlation of the question to the performance score may be determined (act 643). A visualization displaying the level of correlation between each question and the performance score may be generated (act 645). When a question's level of correlation to the performance score is lower than a predetermined threshold, the question may be removed from the task-specific data structure, or the weight of the corresponding question may be reduced (act 646). When a question's level of correlation to the performance score is greater than a predetermined threshold, the weight of the corresponding question may be increased (act 647).

Similarly, for each attribute, a level of correlation of the attribute to the performance score may be determined (act 644). A visualization displaying the level of correlation of each attribute may be generated (act 648). When an attribute's level of correlation to the performance score is lower than a predetermined threshold, the attribute may be removed from the task-specific data structure, or the attribute weight of the corresponding attribute may be decreased (act 649). When an attribute's level of correlation to the performance score is greater than a predetermined threshold, the attribute weight of the corresponding attribute may be increased (act 650).

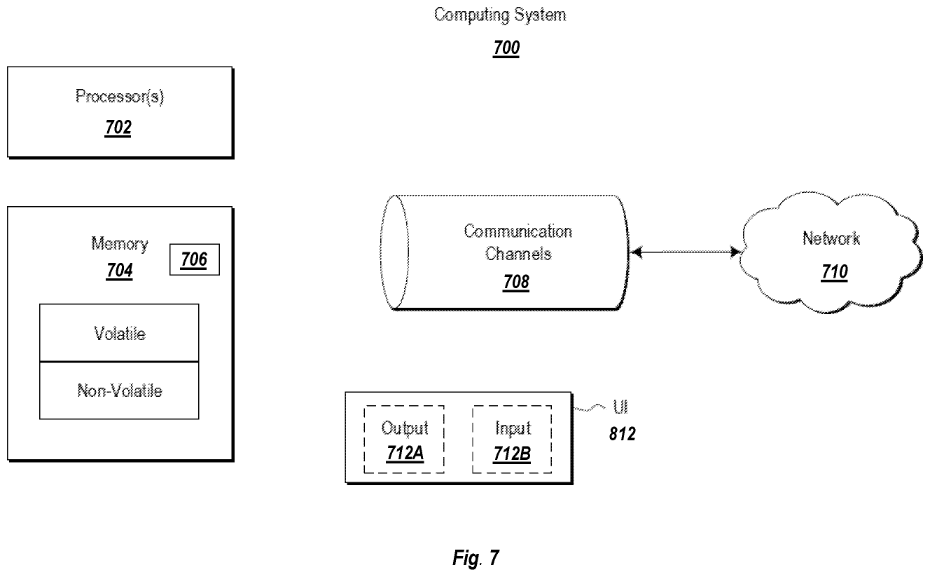

Finally, because the principles described herein may be performed in the context of a computing system (for example, the data structure 100, 200 and/or 300 are all stored in one or more computer-readable hardware devices, and are accessible by one or more computing systems, and each of the reports 400A, 400B, 500A-500D are calculated and generated by a computing system) some introductory discussion of a computing system will be described with respect to FIG. 7.

Computing systems are now increasingly taking a wide variety of forms. Computing systems may, for example, be handheld devices, appliances, laptop computers, desktop computers, mainframes, distributed computing systems, data centers, or even devices that have not conventionally been considered a computing system, such as wearables (e.g., glasses). In this description and in the claims, the term “computing system” is defined broadly as including any device or system (or a combination thereof) that includes one or more physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 8, in its most basic configuration, a computing system 100 typically includes one or more hardware processing unit 702 and memory 704. The processing unit 702 may include a general-purpose processor and may also include a field-programmable gate array (FPGA), an application-specific integrated circuit (ASIC), or any other specialized circuit. The memory 704 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 700 also has thereon multiple structures often referred to as an “executable component”. For instance, memory 704 of the computing system 700 is illustrated as including executable component 706. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such a structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hardcoded or hard-wired logic gates, that are implemented exclusively or near-exclusively in hardware, such as within a field-programmable gate array (FPGA), an application-specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied in one or more computer-readable media that form a computer program product. An example of such an operation involves the manipulation of data. If such acts are implemented exclusively or near-exclusively in hardware, such as within an FPGA or an ASIC, the computer-executable instructions may be hardcoded or hard-wired logic gates. The computer-executable instructions (and the manipulated data) may be stored in the memory 704 of the computing system 700. Computing system 700 may also contain communication channels 708 that allow the computing system 700 to communicate with other computing systems over, for example, network 710.

While not all computing systems require a user interface, in some embodiments, the computing system 700 includes a user interface system 712 for use in interfacing with a user. The user interface system 712 may include output mechanisms 712A as well as input mechanisms 712B. The principles described herein are not limited to the precise output mechanisms 712A or input mechanisms 712B as such will depend on the nature of the device. However, output mechanisms 712A might include, for instance, speakers, displays, tactile output, holograms and so forth. Examples of input mechanisms 712B might include, for instance, microphones, touchscreens, holograms, cameras, keyboards, mouse or other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special-purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general-purpose or special-purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general-purpose computing system, special purpose computing system, or special purpose processing device to perform a certain function or group of functions. Alternatively or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, data centers, wearables (such as glasses) and the like. The invention may also be practiced in distributed system environments where local and remote computing system, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

The remaining figures may discuss various computing system which may correspond to the computing system 700 previously described. The computing systems of the remaining figures include various components or functional blocks that may implement the various embodiments disclosed herein as will be explained. The various components or functional blocks may be implemented on a local computing system or may be implemented on a distributed computing system that includes elements resident in the cloud or that implement aspect of cloud computing. The various components or functional blocks may be implemented as software, hardware, or a combination of software and hardware. The computing systems of the remaining figures may include more or less than the components illustrated in the figures and some of the components may be combined as circumstances warrant. Although not necessarily illustrated, the various components of the computing systems may access and/or utilize a processor and memory, such as processor 702 and memory 704, as needed to perform their various functions.

As mentioned above, the data structures 100, 200 and/or 300 are all stored in one or more computer readable hardware storages and are accessible by one or more computing systems, and each of the reports 400A, 400B, 500A-500D is also calculated and generated by a computing system. As such, the principles described herein are implemented in an environment including one or more computing systems that are configured to communicate with each other directly or indirectly via computer networks. In particular, the method of storing and organizing pre-hiring screening data in a task-specific data structure allows various weighted scores to be diversely generated and displayed to users, which improves the functions of the computing systems of both the database system and the client system that is used to access the database system.

For the processes and methods disclosed herein, the operations performed in the processes and methods may be implemented in differing order. Furthermore, the outlined operations are only provided as examples, an some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing system comprising:
one or more processors; and
one or more computer-readable media having thereon computer-executable instructions that are structured such that, when executed by the one or more processors, cause the computing system to perform a method for storing and organizing pre-hiring screening data of a plurality of candidates in a task-specific data structure and generating weighted scores using different weights for determining each of the plurality of candidates' fitness to a particular task, the method comprising:
accessing the task-specific data structure, the task-specific data structure including a task step table that stores a plurality of task steps, each of the plurality of task steps includes one or more step activities, each of which corresponds to either (1) one or more questions; or (2) one or more assessments:
for each step activity that corresponds to one or more questions,
for each of the one or more questions,
recording one or more question attribute scores, each of which is associated with an attribute and assigned a question weight, the attribute being selected from one of a plurality of attributes;
weighting each of the one or more question attribute scores based on the corresponding question weight; and
aggregating the weighted question attribute scores to generate a question score.

2. The computing system of claim 1, for each step activity that corresponds to one or more assessments,
for each of one or more assessments,
recording a set of data related to the assessment; and
determining one or more assessment attribute scores based on the corresponding set of data, each of the one or more assessment attribute scores being associated with an attribute and being assigned an assessment weight, the attribute being selected from the plurality of attributes;
weighing each of the one or more assessment attribute scores based on the corresponding assessment weight; and
aggregating the weighted one or more assessment attribute scores to generate an overall assessment score.

3. The computing system of claim 2, the method further comprising:
assigning each of the questions a second question weight; and
assigning each of the assessments a second assessment weight.

4. The computing system of claim 3, the method further comprising:
for each step activity that is associated with one or more questions,
weighting each of the question scores based on the second question weight; and
aggregating the weighted question scores to generate an overall step activity score.

5. The computing system of claim 4, the method further comprising:
for each step activity that is associated with one or more assessments,
weighing each of the assessment scores based on the second assessment weight; and
aggregating the weighted assessment scores to generate an overall step activity score.

6. The computing system of claim 5, the method further comprising:
assigning each of the plurality of step activities an activity weight;
weighting each step activity score based on the corresponding activity weight; and
aggregating the weighted step activity score to generate an overall task step score, which indicates how well a candidate may be able to perform the corresponding task step.

7. The computing system of claim 6, the method further comprising:
in response to a determination that a task step score of a particular task step is lower than a predetermined threshold, determining that the candidate is not a qualified candidate.

8. The computing system of claim 6, the method further comprising:
generating a visualization displaying each task step score of a particular candidate.

9. The computing system of claim 3, the method further comprising:
assigning each of the plurality of questions and the plurality of assessments an attribute weight;
for each of the plurality of attributes,
weighting each of the one or more question attribute scores and one or more assessment attribute scores based on the respective attribute weight; and
aggregating the weighted question attribute scores and assessment attribute scores to generate an overall attribute score.

10. The computing system of claim 9, the method further comprising:
assigning each of the plurality of attributes a second attribute weight
dividing the plurality of attributes into one or more groups, each of which includes at least one attribute;
for each of the one or more groups,
weighting each overall attribute score of the at least one attribute contained in the group based on the corresponding second attribute weight; and
aggregating the weighted overall attribute score to generate an attribute group score.

11. The computing system of claim 10, the method further comprising
assigning each of the one or more groups an attribute group weight;
weighing each attribute group score based on the attribute group weight; and
aggregating the weighted attribute group scores to generate an overall task score.

12. The computing system of claim 4, the method further comprising:
generating a visualization displaying the overall task score, each of the attribute group scores, and/or each of the overall attribute scores.

13. The computing system of claim 10, wherein a subset of the plurality of candidates are hired to become one or more employees,
the method further comprises:
for each of the one or more employees, receiving a performance score indicating overall post-hiring performance of the corresponding employee; and
analyzing at least one of the pre-hiring question scores and/or pre-hiring overall attribute scores of each of the one or more employees contained in the data structure with the corresponding employee's performance score.

14. The computing system of claim 13, the method further comprising:
for each question score, determining a level of correlation of the corresponding question score to the performance score of the candidate.

15. The computing system of claim 13, the method further comprising:
generating a visualization displaying the level of correlation of each of the question scores to the performance scores.

16. The computing system of claim 13, the method further comprising:
in response to a determination that a level of correlation of a question is lower than a predetermined threshold, removing the question from the task-specific data structure or reducing the second question weight of the corresponding question in the task-specific data structure; and/or
in response to a determination that a level of correlation of a question is greater than a predetermined threshold, increasing the second question weight of the corresponding question in the task-specific data structure.

17. The computing system of claim 13, for each overall attribute score, determining a level of correlation of the corresponding attribute score to the performance scores.

18. The computing system of claim 13, the method further comprising:
generating a visualization displaying the level of correlation of each of the overall attribute scores to the performance scores.

19. The computing system of claim 16, the method further comprising:
in response to a determination that a level of correlation of an attribute score is lower than a predetermined threshold, removing the attribute from the task-specific data structure or reducing the second attribute weight of the corresponding attribute in the task-specific data structure; and/or
in response to a determination that a level of correlation of an attribute score is greater than a predetermined threshold, increasing the second attribute weight of the corresponding attribute in the task-specific data structure.

20. A computer program product comprising one or more hardware storage devices having stored thereon computer-executable instructions that are structured such that, when executed by one or more processors of a computing system, the computer-executable instructions cause the computer system to perform a method storing and organizing pre-hiring screening data of a plurality of candidates in a task-specific data structure and generating weighted scores using different weights for determining each of the plurality of candidates' fitness to a particular task, the method comprising:
for each step activity that corresponds to one or more questions,
for each of the one or more questions,
recording one or more question attribute scores, each of which is associated with an attribute and assigned a question weight, the attribute being selected from one of a plurality of attributes;
weighting each of the one or more question attribute scores based on the corresponding question weight; and
aggregating the weighted question attribute scores to generate a question score.
